(19) United States
(12) Patent Application Publication
(10) Pub. No.: US 2006/0168042 A1
(43) Pub. Date: Jul. 27, 2006

(54) Mechanism for mitigating the problem of unsolicited email (also known as "spam"

(75) Inventors: Richard H. Boivie, Monroe, CT (US); Jun Tung Fong, Pleasantville, NY (US)

Correspondence Address: MICHAEL J. BUCHENHORNER, ESQ;HOLLAND & KNIGHT, 701 BRICKELL AVENUE, MIAMI, FL, 33131, US

(73) Assignee: International Business Machines Corporation

(21) Appl. No.: 11/031,886

(22) Filed: Jan. 7, 2005

(51) Int. Cl. G06F 15/16

(52) U.S. Cl. 709/206

(57) ABSTRACT

A method for reducing the reception of undesirable email is disclosed. The method includes initiating a first process for receiving email from a first server and receiving an email from the first server. The method further includes identifying the email as an undesirable email and determining an Internet Protocol (IP) address for the first server. The method further includes lowering a priority of the first process when the first process receives email from the first server identified by the IP address.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### FIELD OF THE INVENTION

The invention disclosed broadly relates to the field of electronic mail or email and more particularly relates to the field of detecting and eliminating unsolicited email or spam.

### BACKGROUND OF THE INVENTION

The emergence of electronic mail, or email has changed the face of modern communication. Today, millions of people every day use email to communicate instantaneously across the world and over international and cultural boundaries. The Nielsen polling group estimates that the United States alone boasts 183 million email users out of a total population of 280 million. The use of email, however, has not come without its drawbacks.

Almost as soon as email technology emerged, so did unsolicited email, also known as spam. Unsolicited email typically comprises an email message that advertises or attempts to sell items to recipients who have not asked to receive the email. Most spam is commercial advertising for products, pornographic web sites, get-rich-quick schemes, or quasi-legal services. Spam costs the sender very little to send—most of the costs are paid for by the recipient or the carriers rather than by the sender. Reminiscent of excessive mass solicitations via postal services, facsimile transmissions, and telephone calls, an email recipient may receive hundreds of unsolicited e-mails over a short period of time. On average, Americans receive 155 unsolicited messages in their personal or work email accounts each week with 20 percent of email users receiving 200 or more. This results in a net loss of time, as workers must open and delete spam emails. Similar to the task of handling “junk” postal mail and faxes, an email recipient must laboriously sift through his or her incoming mail simply to sort out the unsolicited spam email from legitimate emails. As such, unsolicited email is no longer a mere annoyance—its elimination is one of the biggest challenges facing businesses and their information technology infrastructure. Technology, education and legislation all have roles in the fight against spam.

Presently, a variety of methods exist for detecting, labeling and removing spam. Vendors of electronic mail servers, as well as many third-party vendors, offer spam-blocking software to detect, label and sometimes automatically remove spam. The following U.S. patents, which disclose methods for detecting and eliminating spam, are hereby incorporated by reference in their entirety: U.S. Pat. No. 5,999,932 entitled “System and Method for Filtering Unsolicited Electronic Mail Messages Using Data Matching and Heuristic Processing,” U.S. Pat. No. 6,023,723 entitled “Method and System for Filtering Unwanted Junk E-Mail Utilizing a Plurality of Filtering Mechanisms,” U.S. Pat. No. 6,029,164 entitled “Method and Apparatus for Organizing and Accessing Electronic Mail Messages Using Labels and Full Text and Label Indexing,” U.S. Pat. No. 6,092,101 entitled “Method for Filtering Mail Messages for a Plurality of Client Computers Connected to a Mail Service System,” U.S. Pat. No. 6,161,130 entitled “Technique Which Utilizes a Probabilistic Classifier to Detect Junk E-Mail by Automatically Updating A Training and Re-Training the Classifier Based on the Updated Training List,” U.S. Pat. No. 6,167,434 entitled “Computer Code for Removing Junk E-Mail Messages,” U.S. Pat. No. 6,199,102 entitled “Method and System for Filtering Electronic Messages,” U.S. Pat. No. 6,249,805 entitled “Method and System for Filtering Unauthorized Electronic Mail Messages,” U.S. Pat. No. 6,266,692 entitled “Method for Blocking All Unwanted E-Mail (Spam) Using a Header-Based Password,” U.S. Pat. No. 6,324,569 entitled “Self-Removing Email Verified or Designated as Such by a Message Distributor for the Convenience of a Recipient,” U.S. Pat. No. 6,330,590 entitled “Preventing Delivery of Unwanted Bulk E-Mail,” U.S. Pat. No. 6,421,709 entitled “E-Mail Filter and Method Thereof,” U.S. Pat. No. 6,484,197 entitled “Filtering Incoming E-Mail,” U.S. Pat. No. 6,487,586 entitled “Self-Removing Email Verified or Designated as Such by a Message Distributor for the Convenience of a Recipient,” U.S. Pat. No. 6,493,007 entitled “Method and Device for Removing Junk E-Mail Messages,” and U.S. Pat. No. 6,654,787 entitled “method and apparatus for filtering e-mail.”

One known method for eliminating spam employs the use of a “decoy” or “honey pot” email account having an address that has never been used to solicit e-mails from third parties, but which address has been publicized so as to attract spam. Thus, no emails are expected or solicited for this email account, perhaps belonging to a fictitious person. Therefore, any emails that are received by this email account are deemed automatically to be, by definition, unsolicited emails, or spam. To filter spam using this method, all incoming mail is first compared with the spam in the honey pot. If the incoming email matches any of the spam in the honey pot, the incoming mail is deemed to be spam and treated accordingly. If the incoming email does not match any of the spam in the honey pot, the incoming email is not deemed to be spam and is delivered to the addressed recipient's mailbox. Unfortunately, spammers attempt to circumvent honey pot spam filters by adding, deleting and/or modifying content (typically textual content) to or in each spam message so that the incoming spam email cannot be matched to spam in the honey pot, and is therefore delivered to the intended recipient.

Therefore, a need exists to overcome the problems with the prior art as discussed above, and particularly for a way to simplify the task of detecting and eliminating spam email.

### SUMMARY OF THE INVENTION

Briefly, according to an embodiment of the present invention, a method for reducing the reception of undesirable email is disclosed. The method includes initiating a first process for receiving email from a first server and receiving an email from the first server. The method further includes identifying the email as an undesirable email and determining an Internet Protocol (IP) address for the first server. The method further includes lowering a priority of the first process when the first process receives email from the first server identified by the IP address.

In another embodiment of the present invention, a first server for reducing the reception of undesirable email is disclosed. The information processing system includes a processor configured for initiating a first process for receiving email from a first server and receiving an email from the first server. The processor is further configured for identifying the email as an undesirable email and determining an Internet Protocol (IP) address for the first server. The processor is further configured for lowering a priority of the first process when the first process receives email from the first server identified by the IP address.

In another embodiment of the present invention, a computer readable medium including computer instructions for reducing the reception of undesirable email. The computer instructions include instructions for initiating a first process for receiving email from a first server and receiving an email from the first server. The computer instructions further include instructions for identifying the email as an undesirable email and determining an Internet Protocol (IP) address for the first server. The computer instructions further include instructions for lowering a priority of the first process when the first process receives email from the first server identified by the IP address.

### BRIEF DESCRIPTION OF THE DRAWINGS

FIG. 1 is block diagram showing the network architecture of one embodiment of the present invention.

FIG. 2 is a flowchart showing the control flow of the process of one embodiment of the present invention.

FIG. 3 is a high level block diagram showing an information processing system useful for implementing one embodiment of the present invention.

### DETAILED DESCRIPTION

The present invention mitigates the problem of unsolicited email, i.e., undesirable email or spam, by identifying a message as spam and applying “backpressure” to the source of spam messages to reduce the volume of email that will be accepted from that source. The advantage of this scheme is that it can identify spam and the source of the spam with a high degree of confidence and apply “backpressure” to the source of the spam to reduce the volume of spam that will be received from that source.

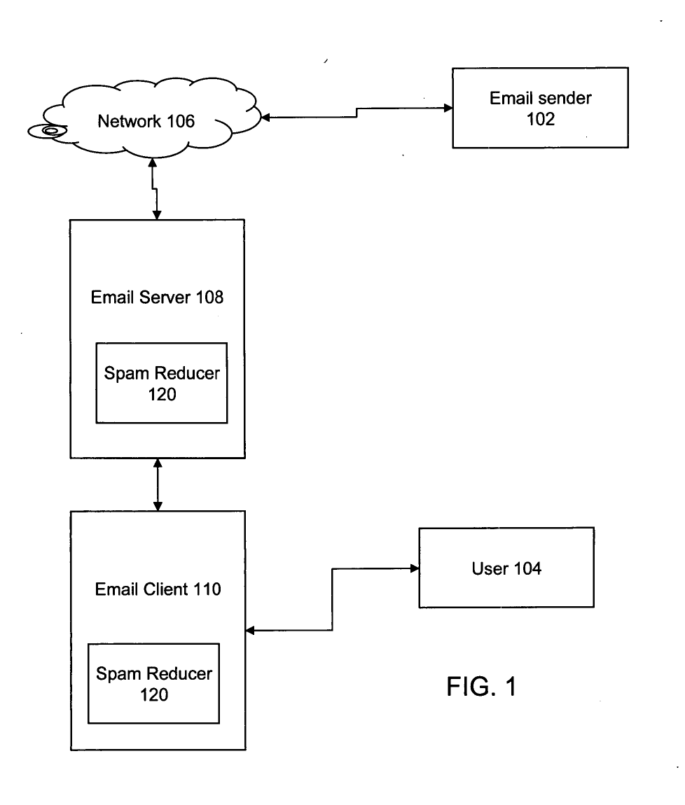

FIG. 1 is block diagram showing a high-level network architecture according to an embodiment of the present invention. FIG. 1 shows an email server 108 connected to a network 106. The email server 108 provides email services to a local area network (LAN) and is described in greater detail below. The email server 108 comprises any commercially available email server system that can be programmed to offer the functions of the present invention. FIG. 1 further shows an email client 110, comprising a client application running on a client computer, operated by a user 104. The email client 110 offers an email application to the user 104 for handling and processing email. The user 104 interacts with the email client 110 to read and otherwise manage email functions.

FIG. 1 further includes a spam reducer 120 for processing email messages and identifying and reducing unsolicited, or spam, email, in accordance with one embodiment of the present invention. The spam reducer 120 can be implemented as hardware, software or any combination of the two. Note that the spam reducer 120 can be located in either the email server 108 or the email client 110 or there-between. Alternatively, the spam reducer 120 can be located in a distributed fashion in both the email server 108 and the email client 110. In this embodiment, the spam reducer 120 operates in a distributed computing paradigm.

FIG. 1 further shows an email sender 102 connected to the network 106. The email sender 102 can be an individual, a corporation, or any other entity that has the capability to send an email message over a network such as network 106. The path of an email in FIG. 1 begins, for example, at email sender 102. The email then travels through the network 106 and is received by a email server 108, where it is optionally processed according to the present invention by the spam reducer 120. Next, the processed email is sent to the recipient, email client 110, where it is optionally processed by the spam reducer 120 and eventually viewed by the user 104. This process is described in greater detail with reference to a flowchart below. In an embodiment of the present invention, the computer systems of the email client 110 and the email server 108 are one or more Personal Computers (PCs) (e.g., IBM or compatible PC workstations running the Microsoft Windows operating system, Macintosh computers running the Mac OS operating system, or equivalent), Personal Digital Assistants (PDAs), hand held computers, palm top computers, smart phones, game consoles or any other information processing devices. In another embodiment, the computer systems of the email client 110 and the email server 108 are a server system (e.g., SUN Ultra workstations running the SunOS operating system or IBM RS/6000 workstations and servers running the AIX operating system). The computer systems of the email client 110 and the email server 108 are described in greater detail below.

In another embodiment of the present invention, the network 106 is a circuit switched network, such as the Public Switched Telephone Network (PSTN). In yet another embodiment, the network 106 is a packet switched network. The packet switched network is a wide area network (WAN), such as the global Internet, a private WAN, a telecommunications network or any combination of the above-mentioned networks. In yet another embodiment, the network 106 is a wired network, a wireless network, a broadcast network or a point-to-point network. It should be noted that although email server 108 and email client 110 are shown as separate entities in FIG. 1, the functions of both entities may be integrated into a single entity. It should also be noted that although FIG. 1 shows one email client 110 and one email sender 102, the present invention can be implemented with any number of email clients and any number of email senders.

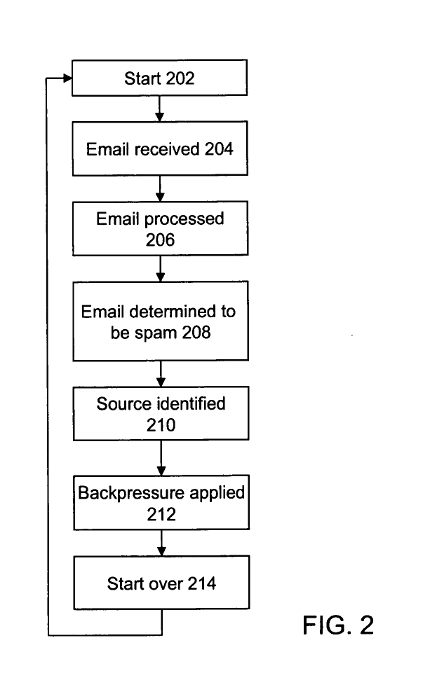

FIG. 2 is a flowchart showing the control flow of one embodiment of the present invention. FIG. 2 summarizes a process on a receiving server of detecting spam and applying backpressure on the source server of the spam email. The control flow of FIG. 2 begins with step 202 and flows directly to step 204.

In step 204, an incoming email is received by the receiving server and in step 206, it is processed to determine whether it is a spam email. In step 208, the incoming email is deemed to be either spam or non-spam email. The incoming email can then be filed, viewed by the user, deleted, or processed, depending on whether or not it is determined to be spam. Following are several examples of mechanisms that can be utilized to determine whether an incoming email is either spam email or non-spam email.

A variety of mechanisms can be used to identify a message as spam. The following are some methods a message might be classified as spam in an enterprise situation where the receiving server is located within a particular network. If an email is received from a source outside of the enterprise and it is addressed to a large number of persons within the enterprise, the email is deemed to be spam. If an email includes certain keywords or key phrases such as “Viagra” or “Get Rich Quick Without Working” in the subject field or in the body of the message, particularly if the mail comes from an external source, the email is deemed to be spam. Spam can also be identified by a person reading his or her email. If an email reading program includes, in addition to the usual reply, forward, save, print and delete options, an option that allows a user to delete an email and mark it as spam, the user can easily help identify spam. This can be particularly useful since spam senders often adopt measures to evade automated spam detection mechanisms.

Once spam has been identified, the next step (in addition to deleting the spam) is to reduce the volume of email that will be accepted from the source or sources of the spam. Since one cannot rely on the information in the “From” field of an email message, because spammers can and often do fill this field with fake information, the Internet Protocol (IP) address from which the spam is received is used to reliably identify the source of the spam. Note that although IP addresses can sometimes be faked (as they often are in denial-of-service attacks) the source address used to transfer mail in a Simple Mail Transfer Protocol (SMTP)—over—Transmission Control Protocol (TCP) connection cannot be faked. If it were, the TCP connection would not work and email could not be transferred. Thus, the IP address that was used in an SMTP session provides a reliable means of identifying the source of a spam.

Assuming that the incoming email is determined to be spam, in step 210 the receiving server determines the source of the spam. In one example, the Internet Protocol (IP) address used in the Simple Mail Transfer Protocol (SMTP) session that garnered the incoming email is used as the identity of the source server of the incoming email. Next, in step 212, the receiving server applies backpressure on the source server of the spam email. Following are several examples of mechanisms that can be utilized to apply backpressure on the source server of the spam email. In one example, the priority of the process that receives email from the source server that was identified is lowered. That is, the process that receives email from the source server is slowed, delayed or completely stopped for a certain period of time. This causes an increased load on the source server as it must hold outgoing email for a longer period of time and/or it belabors the process or delivering email. In another example, a Transmission Control Protocol (TCP) connection to the source server is refused by the receiving server for a certain period of time. In yet another example, all email that is received from the source server is deleted immediately upon reception by the receiving server.

Note that lowering the priority of email from a spam source or refusing connections from a spam source will not only reduce the amount of spam a system will receive but it will also provide backpressure on the source of the spam, transferring some of the cost of the spam back to the source which will have to buffer more mail and hold on to it longer.

In step 214, the control flow of FIG. 5 reverts back to step 204 and the process starts anew. The present invention can be effective against a bulk mail sender that sends from a fixed IP address or a small number of IP addresses. It can also be useful against a spammer that sends mail from an Internet Service Provider (ISP). In this case, the backpressure will be applied to the ISP increasing the likelihood that the ISP will be motivated to reduce the amount of spam that is originating from its servers. The present invention can also be used by an ISP to reduce the amount of spam entering the ISP. The present invention may further be used in other ways to motivate ISP's or other system owners to reduce the amount of spam originating on their systems. For example, a cross industry group might track the principal sources of spam and publish the names of the leading offenders.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following: a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer system to read such computer readable information.

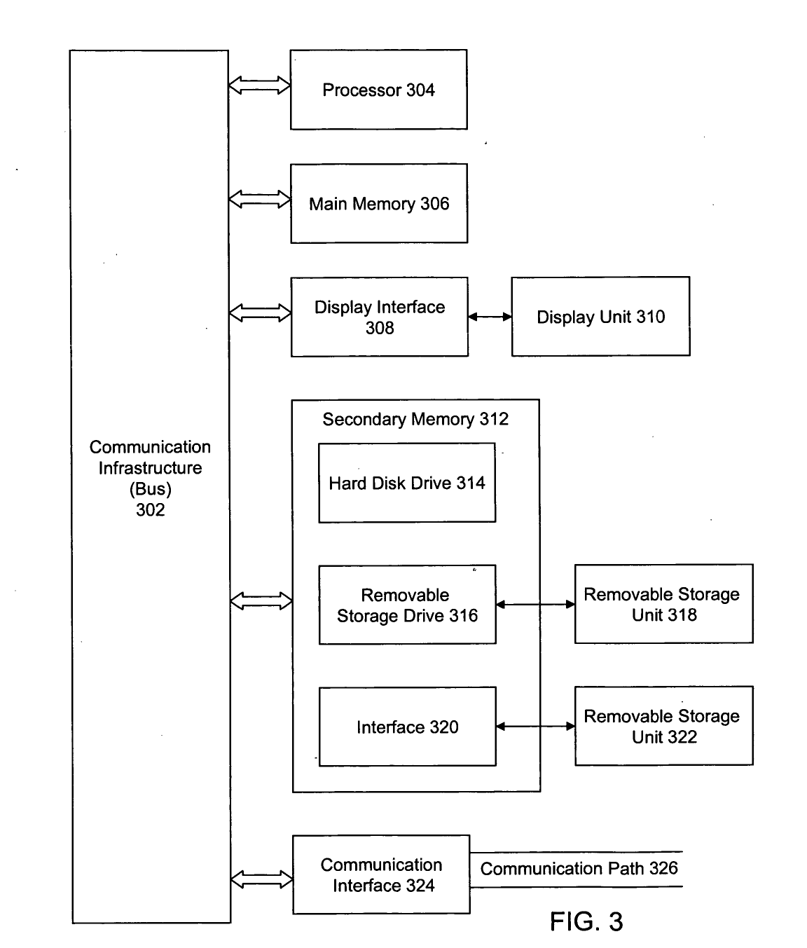

FIG. 3 is a high level block diagram showing an information processing system useful for implementing one embodiment of the present invention. The computer system includes one or more processors, such as processor 304. The processor 304 is connected to a communication infrastructure 302 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 308 that forwards graphics, text, and other data from the communication infrastructure 302 (or from a frame buffer not shown) for display on the display unit 310. The computer system also includes a main memory 306, preferably random access memory (RAM), and may also include a secondary memory 312. The secondary memory 312 may include, for example, a hard disk drive 314 and/or a removable storage drive 316, representing a floppy disk drive, a magnetic tape drive, an optical disk drive, etc. The removable storage drive 316 reads from and/or writes to a removable storage unit 318 in a manner well known to those having ordinary skill in the art. Removable storage unit 318, represents a floppy disk, a compact disc, magnetic tape, optical disk, etc. which is read by and written to by removable storage drive 316. As will be appreciated, the removable storage unit 318 includes a computer readable medium having stored therein computer software and/or data. In alternative embodiments, the secondary memory 312 may include other similar means for allowing computer programs or other instructions to be loaded into the computer system. Such means may include, for example, a removable storage unit 322 and an interface 320. Examples of such may include a program cartridge and cartridge interface (such as that found in video game devices), a removable memory chip (such as an EPROM, or PROM) and associated socket, and other removable storage units 322 and interfaces 320 which allow software and data to be transferred from the removable storage unit 322 to the computer system.

The computer system may also include a communications interface 324. Communications interface 324 allows software and data to be transferred between the computer system and external devices. Examples of communications interface 324 may include a modem, a network interface (such as an Ethernet card), a communications port, a PCMCIA slot and card, etc. Software and data transferred via communications interface 324 are in the form of signals which may be, for example, electronic, electromagnetic, optical, or other signals capable of being received by communications interface 324. These signals are provided to communications interface 324 via a communications path (i.e., channel) 326. This channel 326 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 306 and secondary memory 312, removable storage drive 316, a hard disk installed in hard disk drive 314, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network, that allow a computer to read such computer readable information.

Computer programs (also called computer control logic) are stored in main memory 306 and/or secondary memory 312. Computer programs may also be received via communications interface 324. Such computer programs, when executed, enable the computer system to perform the features of the present invention as discussed herein. In particular, the computer programs, when executed, enable the processor 304 to perform the features of the computer system. Accordingly, such computer programs represent controllers of the computer system.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for reducing the reception of undesirable email, the method comprising:
initiating a first process for receiving email from a first server;
receiving an email from the first server;
identifying the email as an undesirable email;
determining an Internet Protocol (IP) address for the first server; and
lowering a priority of the first process when the first process receives email from the first server identified by the IP address.

2. The method of claim 1, wherein the element of identifying comprises identifying the email as an undesirable email if any one of the following are true:
the first server is an outside network and the email is addressed to a plurality of recipients within the instant network;
the email includes certain words or phrases; and
the email is identified as undesirable by a user.

3. The method of claim 1, wherein the element of determining comprises:
determining an IP address for the first server when email is transferred during a Simple Mail Transfer Protocol—over—Transmission Control Protocol connection between the first process and the first server.

4. The method of claim 1, wherein the element of lowering comprises:
initiating the first process for receiving email;
determining the IP address of the sending server to be the IP address of the first server; and
lowering a priority of the first process.

5. The method of claim 1, further comprising:
refusing a Simple Mail Transfer Protocol—over—Transfer Control Protocol connection between the first process and the first server.

6. The method of claim 1, further comprising:
deleting emails received from the first server.

7. A first server for reducing the reception of undesirable email, comprising a processor configured for:
initiating a first process for receiving email from a first server;
receiving an email from the first server;
identifying the email as an undesirable email;
determining an Internet Protocol (IP) address for the first server; and
lowering a priority of the first process when the first process receives email from the first server identified by the IP address.

8. The first server of claim 7, wherein the element of identifying comprises identifying the email as an undesirable email if any one of the following are true:
the first server is an outside network and the email is addressed to a plurality of recipients within the instant network;
the email includes certain words or phrases; and
the email is identified as undesirable by a user.

9. The first server of claim 7, wherein the element of determining comprises:
determining an IP address for the first server when email is transferred during a Simple Mail Transfer Protocol—over—Transmission Control Protocol connection between the first process and the first server.

10. The first server of claim 7, wherein the element of lowering comprises:
initiating the first process for receiving email;
determining the IP address of the sending server to be the IP address of the first server; and
lowering a priority of the first process.

11. The first server of claim 7, the processor further configured for:
refusing a Simple Mail Transfer Protocol—over—Transmission Control Protocol connection between the first process and the first server.

12. The first server of claim 7, the processor further configured for:
deleting emails received from the first server.

13. A computer readable medium including computer instructions for reducing the reception of undesirable email, the computer instructions including instructions for:
initiating a first process for receiving email from a first server;
receiving an email from the first server;
identifying the email as an undesirable email;
determining an Internet Protocol (IP) address for the first server; and
lowering a priority of the first process when the first process receives email from the first server identified by the IP address.

14. The computer readable medium of claim 13, wherein the instructions for identifying comprise identifying the email as an undesirable email if any one of the following are true:
the first server is an outside network and the email is addressed to a plurality of recipients within the instant network;
the email includes certain words or phrases; and
the email is identified as undesirable by a user.

15. The computer readable medium of claim 13, wherein the instructions for determining comprise:
determining an IP address for the first server when email is transferred during a Simple Mail Transfer Protocol—over—Transmission Control Protocol connection between the first process and the first server.

16. The computer readable medium of claim 13, wherein the instructions for lowering comprise:
initiating the first process for receiving email;
determining the IP address of the sending server to be the IP address of the first server; and
lowering a priority of the first process.

17. The computer readable medium of claim 13, further comprising instructions for:
refusing a Simple Mail Transfer Protocol—over—Transmission Control Protocol connection between the first process and the first server.

18. The computer readable medium of claim 13, further comprising instructions for:
deleting emails received from the first server.
